(19) United States
(12) Patent Application Publication
(10) Pub. No.: US 2026/0172282 A1
(43) Pub. Date: Jun. 18, 2026

(54) DYNAMIC PHYSICAL LAYER COLLISION AVOIDANCE SYSTEM, METHOD AND DEVICE HAVING WAIT BEACON LOCKUP SOLUTION

(71) Applicant: Marvell Asia Pte Ltd, Singapore (SG)

(72) Inventors: Eve Yuhua Huang, San Jose, CA (US); Tsungtang Wang, San Jose, CA (US); Brett Anthony McClellan, Laguna Hills, CA (US)

(21) Appl. No.: 19/421,298

(22) Filed: Dec. 16, 2025

Related U.S. Application Data
(60) Provisional application No. 63/734,737, filed on Dec. 16, 2024.
(60) Provisional application No. 63/734,739, filed on Dec. 16, 2024.
(60) Provisional application No. 63/734,742, filed on Dec. 16, 2024.
(60) Provisional application No. 63/734,748, filed on Dec. 16, 2024.
(60) Provisional application No. 63/734,744, filed on Dec. 16, 2024.

(51) Int. Cl. H04L 12/413; H04L 5/00; H04L 12/40; H04L 69/323

(52) U.S. Cl. CPC H04L 12/413; H04L 5/0053; H04L 12/4015; H04L 69/323

(57) ABSTRACT

A Dynamic PHY-Level Collision Avoidance (DPLCA) system, method and device for implementing and operating an Ethernet network using dynamic physical layer node ID assignments and operating according to a communication protocol that defines repeating time cycles and specifies that each of multiple communication devices is provided a respective transmit opportunity in each time cycle, which enables dynamic addition or deletion of network nodes via assignment of Node IDs.

### RELATED APPLICATIONS

This application claims priority under 35 U.S.C. § 119(e) of the co-pending U.S. provisional patent application Ser. No. 63/734,737 filed Dec. 16, 2024, and titled “IEEE 802.3da DPLCA coordinator lockup solution,” which is hereby incorporated by reference.

This application claims priority under 35 U.S.C. § 119(e) of the co-pending U.S. provisional patent application Ser. No. 63/734,739 filed Dec. 16, 2024, and titled “IEEE 802.3da DPLCA follower lockup solution,” which is hereby incorporated by reference.

This application claims priority under 35 U.S.C. § 119(e) of the co-pending U.S. provisional patent application Ser. No. 63/734,742 filed Dec. 16, 2024, and titled “IEEE 802.3da DPLCA node count detection,” which is hereby incorporated by reference.

This application claims priority under 35 U.S.C. § 119(e) of the co-pending U.S. provisional patent application Ser. No. 63/734,748 filed Dec. 16, 2024, and titled “IEEE 802.3da DPLCA coordinator not able to transition to LEARNING state solution,” which is hereby incorporated by reference.

This application claims priority under 35 U.S.C. § 119(e) of the co-pending U.S. provisional patent application Ser. No. 63/734,744 filed Dec. 16, 2024, and titled “IEEE 802.3da DPLCA control state WAIT_BEACON lockup solution,” which is hereby incorporated by reference.

### FIELD OF INVENTION

The present invention relates to dynamic physical layer collision avoidance (DPLCA) systems, methods and devices. More particularly, the present invention relates to preventing wait_beacon lockup in DPLCA systems, methods and devices.

### BACKGROUND OF THE INVENTION

Transferring information between computers and other electronic devices can be implemented using a variety of different standards and technologies. Ethernet is a desirable protocol for networking. However, an issue with Ethernet is that the Ethernet PHY standards are often written for “point to point” network topology. In such networks, only two nodes are connected to each other at a time via a given physical wire. Nodes that are not directly connected to the same wire communicate to each other via packet switching equipment. Shared cabled based systems are called “multi-drop” systems. Sometimes such systems are also known as “mixing segment” based systems. There are some Ethernet standards that support multi-drop topology. However, the existing Ethernet mechanisms are not conducive to applications that desire plug and play deployment such as industrial automation over single twisted-pair cables.

One type of multi-drop Ethernet network provides means for operation over coaxial network using CSMA-CD (Carrier-sense multiple access with collision detection) access mechanism. CSMA-CD is a collision and collision-detection based networking protocol. Due to efficiency and scalability issues, such systems are rarely used in current Ethernet communication systems. TDM (time division multiplexing) is another mechanism used in some shared channel systems. In a TDM system, fixed time slots are allocated to nodes which results in pre-determined bandwidth allocation to the nodes. TDM systems are wasteful in bursty traffic scenarios when certain nodes under-utilize their allocation of bandwidth. Recently IEEE P802.3cg defined a protocol for Ethernet networks using a PHY Level Collision Avoidance (PLCA) mechanism to improve the bandwidth utilization efficiency of the system compared to TDM networks. PLCA requires a management entity to assign the node identification (ID) used to determine time slot allocation, which prevents dynamic and automatic provisioning of the network. This constraint is undesirable as it prevents Hot-insertion and Hot-removal of nodes from the network making the network not plug and play capable.

### BRIEF SUMMARY OF THE INVENTION

A Dynamic PHY-Level Collision Avoidance (DPLCA) system, method and device for implementing and operating an Ethernet network using dynamic physical layer node ID assignments and operating according to a communication protocol that defines repeating time cycles and specifies that each of multiple communication devices is provided a respective transmit opportunity in each time cycle, which enables dynamic addition or deletion of network nodes via assignment of Node IDs.

A first aspect is directed to a single pair ethernet multidrop network that operates according to a communication protocol incorporating dynamic physical layer collision avoidance, the protocol defining repeating communication cycles each including one or more transmission opportunity windows and specifying that each of a plurality of nodes is provided one of the transmission opportunity windows in each of the communication cycles. The network comprises a network bus and the plurality of nodes each coupled to the network bus for communicating with each other, wherein one of the nodes selects a local node identifier having a highest value supported by the network and while the local node identifier of the one of the nodes is the highest value supported by the network, the one of the nodes is configured to enter a disable state when a stored dplca_en value indicates that dynamic physical layer collision avoidance features are not enabled for the one of the nodes and refrain from entering the disable

state when the stored dplca_en value indicates that the dynamic physical layer collision avoidance features are enabled for the one of the nodes.

In some embodiments, when in the disable state, while the local node identifier of the one of the nodes is the highest value supported by the network, the one of the nodes is configured to transition from the disable state to a resync state based on the dynamic physical layer collision avoidance features being enabled for the one of the nodes. In some embodiments, when in the disable state, while the local node identifier of the one of the nodes is the highest value supported by the network, the one of the nodes is configured to transition from the disable state to a resync state based on the local identifier of the one of the nodes being not equal to a lowest value supported by the network. In some embodiments, the lowest value supported by the network is 0 and the highest value supported by the network is 255. In some embodiments, when in the disable state, the one of the nodes does not transmit data on the network bus. In some embodiments, the communication protocol incorporates IEEE 802.3da. In some embodiments, the network bus comprises one of a single pair twisted cable and a segmented cable.

A second aspect is directed to a network node for communicating in a single pair ethernet multidrop network that operates according to a communication protocol incorporating dynamic physical layer collision avoidance, the protocol defining repeating communication cycles over a network bus each including one or more transmission opportunity windows and specifying that each of the network node and a plurality of other nodes on the network is provided one of the transmission opportunity windows in each of the communication cycles. The network node comprises a memory, a processor coupled with the memory and an ethernet communication component for communicating with the other nodes via a network bus, wherein the communication component selects a local node identifier having a highest value supported by the network and while the local node identifier of the communication component is the highest value supported by the network, the communication component enters a disable state when a stored dplca_en value indicates that dynamic physical layer collision avoidance features are not enabled for the communication component and refrains from entering the disable state when the stored dplca_en value indicates that the dynamic physical layer collision avoidance features are enabled for the communication component.

In some embodiments, when in the disable state, while the local node identifier of the communication component is the highest value supported by the network, the communication component is configured to transition from the disable state to a resync state based on the dynamic physical layer collision avoidance features being enabled for the communication component. In some embodiments, when in the disable state, while the local node identifier of the communication component is the highest value supported by the network, the communication component is configured to transition from the disable state to a resync state based on the local identifier of the communication component being not equal to a lowest value supported by the network. In some embodiments, the lowest value supported by the network is 0 and the highest value supported by the network is 255. In some embodiments, when in the disable state, the communication component does not transmit data on the network bus. In some embodiments, the communication protocol incorporates IEEE 802.3da. In some embodiments, the network bus comprises one of a single pair twisted cable and a segmented cable.

Another aspect is directed to a method of providing a single pair ethernet multidrop network that operates according to a communication protocol incorporating dynamic physical layer collision avoidance, the protocol defining repeating communication cycles each including one or more transmission opportunity windows and specifying that each of a plurality of nodes is provided one of the transmission opportunity windows in each of the communication cycles. The method comprises with a first node of the plurality of nodes coupled to a network bus of the network selecting a local node identifier having a highest value supported by the network and while the local node identifier of the first node is the highest value supported by the network entering a disable state when a stored dplca_en value indicates that dynamic physical layer collision avoidance features are not enabled for the first node and refraining from entering the disable state when the stored dplca_en value indicates that the dynamic physical layer collision avoidance features are enabled for the first node.

In some embodiments, the method further comprises, when in the disable state and while the local node identifier of the first node is the highest value supported by the network, transitioning from the disable state to a resync state with the first node based on the dynamic physical layer collision avoidance features being enabled for the first node. In some embodiments, the method further comprises when in the disable state and while the local node identifier of the first node is the highest value supported by the network, transitioning from the disable state to a resync state with the first node based on the local identifier being not equal to a lowest value supported by the network. In some embodiments, the lowest value supported by the network is 0 and the highest value supported by the network is 255. In some embodiments, when in the disable state, the first node does not transmit data on the network bus. In some embodiments, the communication protocol is IEEE 802.3da. In some embodiments, the network bus comprises one of a single pair twisted cable and a segmented cable.

Another aspect is directed to a single pair ethernet multidrop network that operates according to a communication protocol incorporating dynamic physical layer collision avoidance, the protocol defining repeating communication cycles each including one or more transmission opportunity windows and specifying that each means for communicating is provided one of the transmission opportunity windows in each of the communication cycles. The network comprises means for transmitting electronic data and the means for communicating each coupled to the means for transmitting for communicating with each other, wherein one of the means for communicating selects a local node identifier having a highest value supported by the network and while the local node identifier of the one of the means for communicating is the highest value supported by the network, the one of the means for communicating is configured to enter a disable state when a stored dplca_en value indicates that dynamic physical layer collision avoidance features are not enabled for the one of the means for communicating and refrain from entering the disable state when the stored dplca_en value indicates that the dynamic physical layer collision avoidance features are enabled for the one of the means for communicating.

### BRIEF DESCRIPTION OF THE DRAWINGS

FIG. 1 illustrates a block diagram of an Ethernet system implementing DPLCA according to some embodiments.

FIG. 2 illustrates a block diagram of the ethernet communication component according

to some embodiments.

FIG. 3 illustrates a method of providing a single pair ethernet multidrop network according to some embodiments.

FIG. 4 illustrates an ethernet communication component control state diagram according to some embodiments.

FIG. 5 illustrates another method of providing a single pair ethernet multidrop network according to some embodiments.

FIGS. 6A and 6B illustrate ethernet communication component control state diagrams according to some embodiments.

FIG. 7 illustrates another method of providing a single pair ethernet multidrop network according to some embodiments.

FIG. 8 illustrates ethernet communication component control state diagrams according to some embodiments.

FIG. 9 illustrates another method of providing a single pair ethernet multidrop network according to some embodiments.

FIG. 10 illustrates ethernet communication component control state diagrams according to some embodiments.

FIG. 11 illustrates another method of providing a single pair ethernet multidrop network according to some embodiments.

### DETAILED DESCRIPTION OF THE INVENTION

In the following description, numerous details are set forth for purposes of explanation. However, one of ordinary skill in the art will realize that the invention can be practiced without the use of these specific details. Thus, the present invention is not intended to be limited to the embodiments shown but is to be accorded with the widest scope consistent with the principles and features described herein.

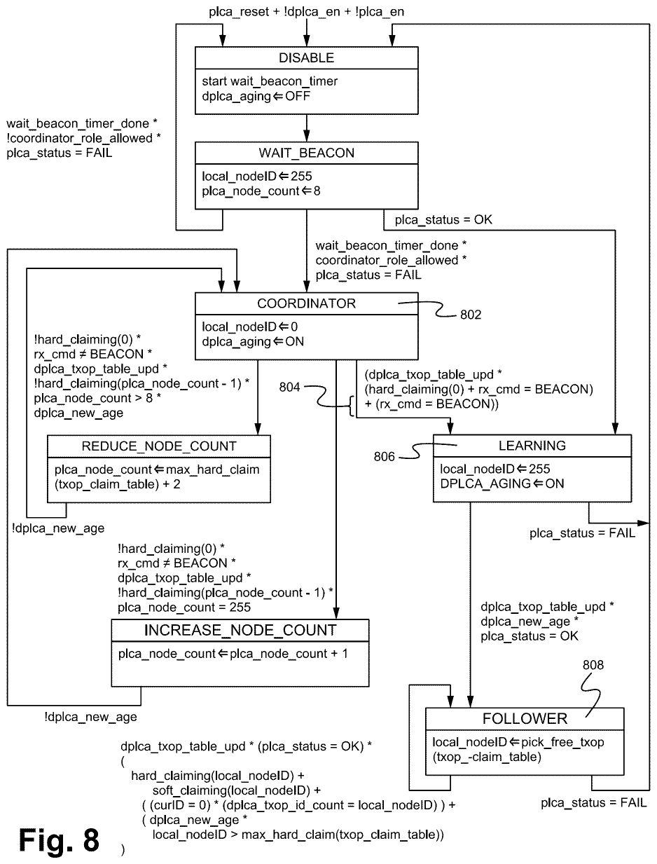

Embodiments are directed to a Dynamic PHY-Level Collision Avoidance (DPLCA) system, method and device for implementing and operating an Ethernet network using dynamic physical layer node ID assignments, which enables dynamic addition or deletion of network nodes via assignment of Node IDs. In some embodiments, the methods, devices, and systems are able to provide for an Ethernet network over multi-drop topologies. Further, the described embodiments are able to comprise transmitting and receiving Ethernet signals and data over shared cabling and multiple Ethernet nodes. The described embodiments include Ethernet network nodes that are capable of dynamic network node configuration via a Dynamic PHY-Level Collision Avoidance (DPLCA) mechanism. In particular, in some embodiments the DPLCA system, method and device operate according to Institute for Electrical and Electronics Engineers (IEEE) Standard 802.3da draft 1.0 (an amendment to “IEEE Standard for Ethernet,” in IEEE Std 802.3-2022 (Revision of IEEE Std 802.3-2018), pp. 1-7025, 29 Jul. 2022), including the state diagrams in Figure 148-8 and 148-9 thereof, except for the differences described herein. Accordingly, the IEEE Standard 802.3da draft 1.0 is hereby incorporated by reference in its entirety.

Further, the described embodiments relate to information networks and specifically to transmitting Ethernet information over communication lines such as coaxial cable (hereinafter “coax”) or twisted-pair cables, thereby forming an Ethernet based Local Area Network (LAN). More specifically, the described embodiments relate to shared-medium Ethernet networks, also referred to as multi-drop networks, capable of operating with multiple nodes connected to a “mixing segment.” Mixing segment is an IEEE defined term for shared wiring. Such shared-wiring networks can be referred to as multi-drop networks.

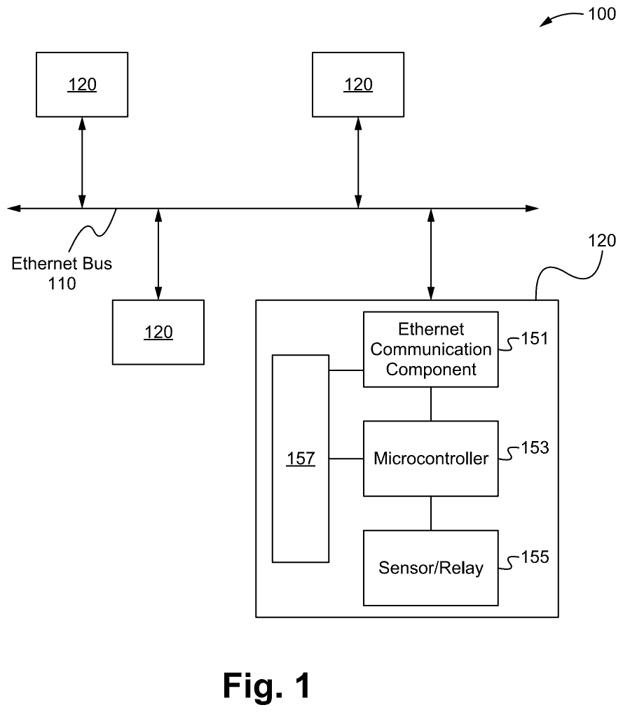

FIG. 1 illustrates a block diagram of an Ethernet system 100 implementing DPLCA according to some embodiments. As shown in FIG. 1, the system comprises one or more Ethernet nodes 120 electrically and/or operably coupled to an Ethernet bus 110. The Ethernet bus 110 is able to comprise a shared cable (e.g. single pair cable) or a segmented cable (as described above). Although as shown in FIG. 1, the system 100 comprises four nodes 120, more or less nodes 120 are contemplated. In some embodiments, the cable includes one or more mixing segments (e.g. a 10BASE-T1M mixing segment having a single balanced pair of conductors that is able to have more than two media dependent interfaces (MDIs) attached). The ethernet nodes 120 are each able to comprise memory 157, an ethernet communication (software and/or hardware) component 151, a processor and/or microcontroller 153 and a sensor/relay 155. The memory 157 is able to comprise one or more registers, one or more locations in a memory device such as a RAM, a solid state memory, and/or other memory components. In some embodiments, the sensory/relay 155 is able to be omitted. Each node 120 is capable of transmitting and receiving data to/from the other nodes 120 over the bus 110. Additionally, in some embodiments one or more of the nodes 120 comprise application layer circuitry.

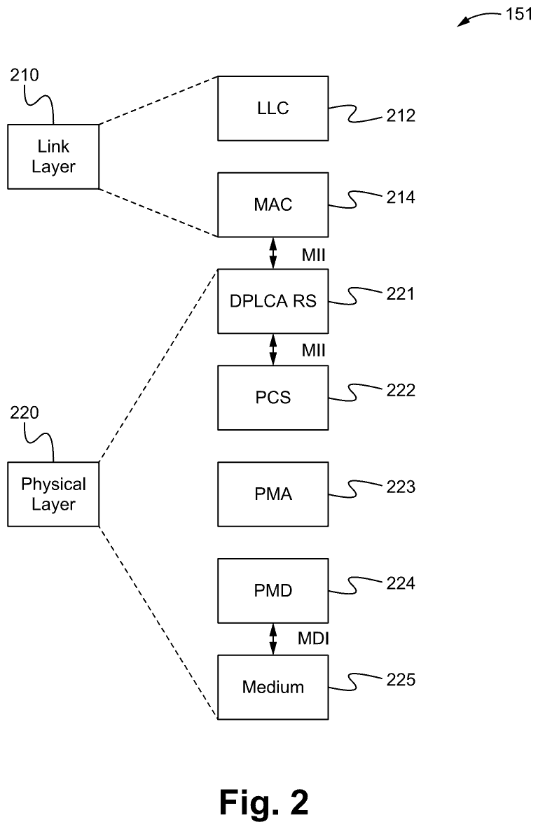

FIG. 2 illustrates a block diagram of the ethernet communication component 151 according to some embodiments. As shown in FIG. 2, the component 151 is able to comprise link layer 210 and physical layer 220 circuitry. The link layer 210 is able to include Ethernet sublayers such as MAC (Medium Access Control) 214 and LLC (Logical Link Control) 212. The Physical layer 220 circuitry is able to comprise sublayers, such as, a Physical media dependent sublayer (PMD) 224, a Physical media access sublayer (PMA) 223, a Physical coding sublayer (PCS) 222, a DPLCA layer 221 and a physical medium layer 225. The Physical Layer 224 is able to interface with the transmission medium. The physical media access sublayer (PMA) 223 is able to provide transmission, reception, collision detection, clock recovery and skew alignment functions. The PCS 222 is able to encode data bits for transmission via the PMA 223 and to decode the received conditioned signals from the PMA 223. The DPLCA 221 is able to dynamically obtaining a Node ID for the node 120 and perform dynamic PHY level collision avoidance functions.

In operation, each of the Ethernet nodes 120 is able to autonomously dynamically select and store a unique node identifier to be its local or temporary node ID (e.g. local_nodeID). Specifically, the nodes 120 are able to start out in a disabled state (e.g. powered off, not coupled to the bus 110, or otherwise not in active operation) and upon becoming active and/or coupled to the bus 110, the nodes 120 are able to switch to a learning state. In this learning state, the nodes are able to select a unique node identifier as their temporary node ID. In particular, selecting the unique node identifier as a temporary node ID is able to comprise listening for a full communication cycle (e.g. until two beacon signals have been received and/or for a time corresponding to the maximum time slot duration multiplied by the maximum or current number of nodes 120), and if a beacon signal is received during the cycle (or a coordinator role parameter of the node 120 is not enabled): identifying the unique node identifier corresponding to one or more available time slots (e.g. time slots during which no signals and/or particular signals were not transmitted (e.g. present, carrier, commit and/or data signals) during that cycle or for a predetermined number of cycles), and selecting one of the identified unique node identifiers corresponding to the available time slots (e.g. set local_nodeID equal to the output of pick_free_txop (txop_claim_table).

In some embodiments, the nodes 120 generate and store a table (e.g. txop_claim_table) that includes all of the current time slots/unique node IDs along with an indication of whether they are currently available (and/or a count associated with each possibly available time slot/node ID identifying how many cycles have passed without any transmitted data during that time slot/node ID). Similarly, during the listening in some embodiments the nodes 120 are able to initialize a node count value (e.g. plca_node_count) to a default number of nodes/node IDs/time slots (e.g. 8). Indeed, if the node 120 becomes a coordinator node, they are able to continuously update the node count value to increase or decrease the number of nodes/node IDs/time slots that the coordinator node is going to support for that cycle. Alternatively, the listening for a full communication cycle and/or determining if a beacon signal is received is able to be performed while in the disabled state (or and associated wait beacon state), and the transition to the learning and/or coordinator states only occurs after the listening is completed.

After selecting a unique node identifier (that is not the coordinator node ID) as its temporary node ID, each node 120 is able to: transmit over the Ethernet bus 110 either a special symbol/packet during a time slot (or transmit opportunity) that is designated for the unique node identifier; monitor any collisions with the transmitted special symbol/packet; and autonomously select the unique node identifier if no collision is detected. This transmission is able to be a soft claim on the selected unique node identifier in order to determine if use of the selected unique node identifier is not in conflict with any other of the nodes 120. In some embodiments, claim is considered a soft claim, when the transmission of data occurs without first transmitting a “commit” message to the other nodes 120 within the same time slot/transmission opportunity (which would indicate that the node 120 is issuing a hard claim on the selected unique node ID). Alternatively, the transmission is able to be a hard claim (where a “commit” message/signal is transmitted before the transmission of the data. Alternatively, whether a commit signal is first transmitted or not, the transmission is able to be considered a generic claim (wherein the system 100 does not distinguish between hard and soft claims). Indeed, although one or more of the claims are described herein as either soft or hard claims, it is understood that some or all of the claims are able to be treated as generic claims (e.g. wherein the sending or non-sending of a commit signal before data transmission is not used to distinguish the claims).

The monitoring and detecting of collisions (e.g. beacon and/or other data collisions on the bus 110) is able to include receiving a corrupted signal due to a transmission by another of the nodes 120 that is present (connected to) on the bus 110, wherein the other node 120 and the current node 120 were transmitting at the same time. In other words, after selecting the unique node ID, the current node 120 tries to transmit data during the time slot dedicated to that unique node ID. If another of the nodes 120 has also or already selected the same unique node ID, it will also attempt to transmit data during that same time slot resulting in the collision.

As a result of the detected collision, the current node 120 is able to: determine that the selected unique node ID was already taken (by the other node 120); select a different unique node identifier; transmit special symbol/packet during a time slot (or transmit opportunity) that is designated for the different unique node identifier; and monitor any collisions with the transmitted special symbol/packet. This operation is repeated until a collision is not detected for a particular unique node identifier at which point the node 120 autonomously selects the particular unique node identifier as its set unique node ID. In some embodiments, subsequently during the next time slot associated with the particular unique node identifier, the node 120 is able to issue a claim (e.g. hard claim or generic claim) on the particular unique node identifier by first transmitting a “commit” message to the other nodes 120 before transmitting any other data during the time slot.

The unique node identifier selected each time is able to be autonomously selected according to a sequence determined by the DPLCA 221. In some embodiments, the sequence starts with any available unique node identifier (e.g. any unique node identifier that is not the coordinator node ID and has not already been claimed by another node 120). Alternatively, the sequence is able to start with a lowest available unique node identifier (that is not the coordinator node ID) and increment up (e.g. to a second lowest available unique node identifier) after each collision. In any case, this enables nodes 120 to dynamically join the system 100 by (physically, virtually or operatively) coupling to the bus 110 and establishing a unique node identifier that has not already been taken. Similarly, nodes 120 are able to dynamically leave the system 100 by (physically, virtually or operatively) decoupling from the bus 110 thereby releasing any claim on the unique node ID that they had been using. Alternatively, one or more of the nodes 120 are able to have a statically or manually configured unique node identifier such that they do not need to perform the above process.

If instead while attempting to select a unique node ID a beacon signal is not received (and a coordinator role parameter of the node 120 is enabled (e.g. coordinator_role_allowed=true), the node 120 is able to attempt to become the coordinator for the system 100. Specifically, the node is able to select the lowest node ID as its temporary node ID and listen for a beacon signal (from another node 120) for a wait_beacon_timer duration. If the node 120 does not hear a beacon signal (or a commit signal) on the bus 110 during the wait_beacon_timer duration, the node 120 switches to a coordinator state and transmits a beacon signal over the bus 110 to the other nodes 120. If no collisions with other beacon signals (from other nodes 120) occur, the node 120 is then able to enter normal operation as described below, except that because it is in the coordinator state it sends out the beacon signal after all of the time slots (or transmit opportunities) have elapsed (and/or adjusts the number of time slots). If a beacon signal collision occurs (e.g. because two or more of the nodes 120 transmitted a beacon signal before receiving the beacon signal transmitted by the other nodes), in order to prevent or minimize the chance of coordinator lockup, the node 120 is able to switch from the coordinator state back to the learning state wherein it repeats the process of selecting a unique node ID as its temporary node ID as described above.

In order to reduce the number of beacon collisions (and/or coordinator lockup resulting therefrom), in some embodiments when in the disabled state, the DPLCA 221 of each node 120 is able to be configured to change and/or initialize the wait_beacon_timer duration to be a random value (e.g. that is less than or equal to the maximum time slot/transmit opportunity duration). Further, in such embodiments (or separate from such embodiments), if soft claiming occurs during the first transmit opportunity, any nodes 120 in the coordinator state are able to be configured to transition to the learning state. Specifically, the occurrence of soft claiming (e.g. transmitting data during a time slot without first sending a commit signal) is a strong indicator of a beacon collision, and thus enabling the nodes 120 in the coordinator state to transition to the learning state when that occurs reduces the likelihood of another beacon collision in the next communication cycle. Alternatively, if generic claiming (e.g. not specified as hard or soft, just data transmitted during the time slot) occurs during a communication cycle, any nodes 120 in the coordinator state are able to be configured to transition to the learning state. Alternatively, regardless of soft, hard or generic claiming, the transition from the coordinator state to the learning state is able to be omitted. Moreover, in such embodiments (or separate from such embodiments), each node 120 is able to be configured to switch from the learning state to the disabled state upon detecting a beacon collision. Indeed, in combination with the randomization of the wait_beacon_timer duration in the disabled state, this provides the benefit of two or more nodes 120 that were the source of a beacon collision each having their wait_beacon_timer duration randomized thereby reducing the chance of a subsequent collision. As a result, the system 100 provides the advantage of reducing the likelihood of beacon collisions thereby increasing the efficiency and/or data throughput of the system 100.

Conversely, if the node 120 receives a beacon signal during the wait_beacon_timer duration, the node 120 transitions from the wait_beacon state back to the learning state and attempts to select a temporary unique node ID as described above. In summary, if their coordinator role parameter is enabled, the nodes 120 automatically self-assign the role of coordinator node if needed, and then operate as coordinator node, until another node 120 steals the coordinator role (e.g. by transmitting a beacon signal) or the coordinator node 120 malfunctions, is powered down or is unplugged. Alternatively, the coordinator node 120 is able to be manually or otherwise chosen (and/or rechosen if the previous coordinator node 120 stops responding or otherwise disconnects from the system 100).

Once a unique node identifier has been established (e.g. hard claimed or generically claimed) by the node 120, normal operation is able to occur. In such operation, the coordinator node 120 is able to operate in a coordinator state and the other nodes are able to operate in a follower state as described below. Specifically, a communications cycle is initiated when the coordinator node 120 sends a beacon message/signal to the other nodes 120 on the bus 110 that other nodes 120 use to coordinate their clocks. During the communications cycle, each node 120 gets a time slot or “Transmit Opportunity” (TO) window based on its unique node ID in which the node 120 is able to start transmitting data. In order to determine when it is their time slot, the nodes 120 listen to messages on the bus 110 and determine when the node 120 with a unique node ID one fewer than their set unique node ID has finished transmitting during their time slot (or a current time has reached the end of that time slot), after which the nodes 120 determine that the current time slot is assigned to them. Generally, the coordinator node 120 is given the first time slot following sending out the beacon signal.

If a given node 120 has no data to transmit (e.g. no data from the MAC 214) during its time slot, the node 120 remains silent during the time slot. If the node 120 has data to transmit, it transmits the data on the bus 110 during its time slot. After a given node 120 finishes transmission of its data (or the time slot window ends), the node 120 corresponding to the next time slot is able to similarly transmit or be silent during its time slot. In some embodiments, being silent is able to comprise sending a signal (e.g. a present signal) that indicates that the node 120 is on the network, but there is no data to transmit such that the time slot is able to be ended immediately (rather than waiting for the full duration to start the next time slot). In some embodiments, if a node 120 has internal delay between the link and physical layers 210, 220 (e.g. due to integrated circuit implementations), it is able to transmit a commit signal during its time slot in order to hold its place in line until it is ready to transmit data. The process of listening and/or transmitting is repeated until all the time slots have expired (e.g. all the nodes have had an opportunity to send data). The communications cycle is completed at that time, and the coordinator node 120 is able to initiate the next cycle by sending another beacon signal. In some embodiments, the maximum number of nodes 120 allowed on the bus 110/system 100 is determined by the network administrator and is known by the coordinator node 120. As a result, the coordinator node 120 is able to know when all of the time slots have passed and it is okay to start the next communication cycle (e.g. after such known number of nodes have taken the turn to transmit).

In some embodiments, the coordinator node 120 is able to adjust the number of time slots/transmission opportunities provided in each communication cycle. For example, if less than all of the time slots/transmission opportunities have been used to transmit data for one or more communication cycles, the coordinator node 120 is able to reduce the number of time slots/transmission opportunities provided in the next communication cycle. Similarly, if there are more nodes 120 attempting to join the network 110 than there are time slots/transmission opportunities in a communication cycle, the coordinator node 120 is able to increase the number of time slots/transmission opportunities in the next communication cycle. This adjustment of the number of time slots/transmission opportunities provided each communication cycle is able to be dynamically performed before the start of each subsequent communication cycle in order to customize the size of the communication cycle to the current need (as defined by the number of nodes that currently need to use the network 110).

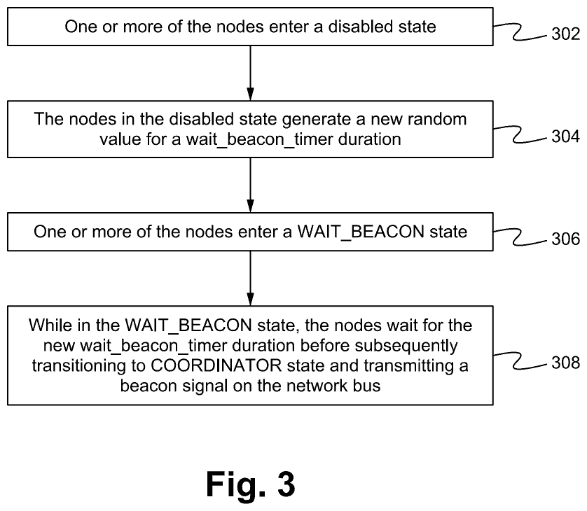

FIG. 3 illustrates a method of providing a single pair ethernet multidrop network according to some embodiments. As shown in FIG. 3, one or more the nodes 120 enter a disabled state at the step 302. In some embodiments, the nodes 120 enter a disabled state upon initially coupling to the bus 110. Alternatively or in addition, the nodes 120 are able to enter the disabled state after having already been coupled to the bus 110 (e.g. after malfunctioning and/or otherwise physically or operably disconnecting from the network/bus 110). The nodes 120 in the disabled state generate a new random value for a wait_beacon_timer duration at the step 304. The new value is able to be a random positive value that is less than a maximum duration of a time slot/transmit opportunity for that network. In some embodiments, the nodes 120 are able to comprise a random number generator that facilitates the generation of the new random value. One or more of the nodes 120 enter the wait beacon at the step 306. While in the wait beacon state, the nodes 120 wait for the new wait_beacon_timer duration before subsequently transitioning to the coordinator state and transmitting a beacon signal on the network bus 110 at the step 308.

In some embodiments, the method further comprises with each of the nodes 120, transitioning from the coordinator state to a learning state upon detecting a soft claim during one of the transmission opportunity windows. In some embodiments, the method further comprises with the nodes 120, waiting for the new wait_beacon_timer duration, transmitting the beacon signal on the bus 110 and transitioning to the coordinator state when the nodes 120 do not receive any beacon signals during one of the communication cycles while in the learning state. In particular, the nodes 120 are able to transition from the learning state through the disabled state to the wait beacon state (where it waits for the wait beacon timer) and then transitions to the coordinator state after the wait beacon time duration has elapsed. In some embodiments, the method further comprises with each of the nodes 120 that are currently in the learning state, upon detection of a beacon collision (comprising a collision of two or more beacon signals on the network bus concurrently), transitioning to the disabled state and generating another new random value for the wait_beacon_timer duration. In some embodiments, the coordinator enable parameter of each of the nodes has a value that indicates that the node is permitted to enter the coordinator state. In some embodiments, the communication protocol is IEEE 802.3da. In some embodiments, the network bus 110 comprises one of a single pair twisted cable and a segmented cable.

### Follower Lockup

In some embodiments both in normal operation and when trying to determine an available unique node identifier as described above, follower nodes 120 (e.g. nodes 120 that are not performing coordinator functions) are able to cause collisions by transmitting data (e.g. a commit signal and/or other data) onto the bus 110 at the same time (or concurrently with) other follower nodes 120 (e.g. during the same time slot/transmit opportunity). In particular, this can occur when two or more follower nodes 120 have selected the same node identifier and have data to send such that when the time slot/transmit opportunity corresponding to that node identifier arrives, all of those follower nodes attempt to transmit data during that time slot/transmit opportunity resulting in the collision. In IEEE 802.3da, because the follower nodes are unable to detect activity from other nodes while transmitting data (i.e. packets), the follower nodes are prevented from selecting a new unique node identifier and thus get stuck in a follower lockup situation. In other words, follower lockup occurs because two nodes asserting to have the same node identifier continue to send packets during the same time slot/TO and the nodes 120 are unable to register the transmission activity from the other nodes 120 while transmitting the packets such that it cannot record a soft, hard and/or generic claim while transmitting.

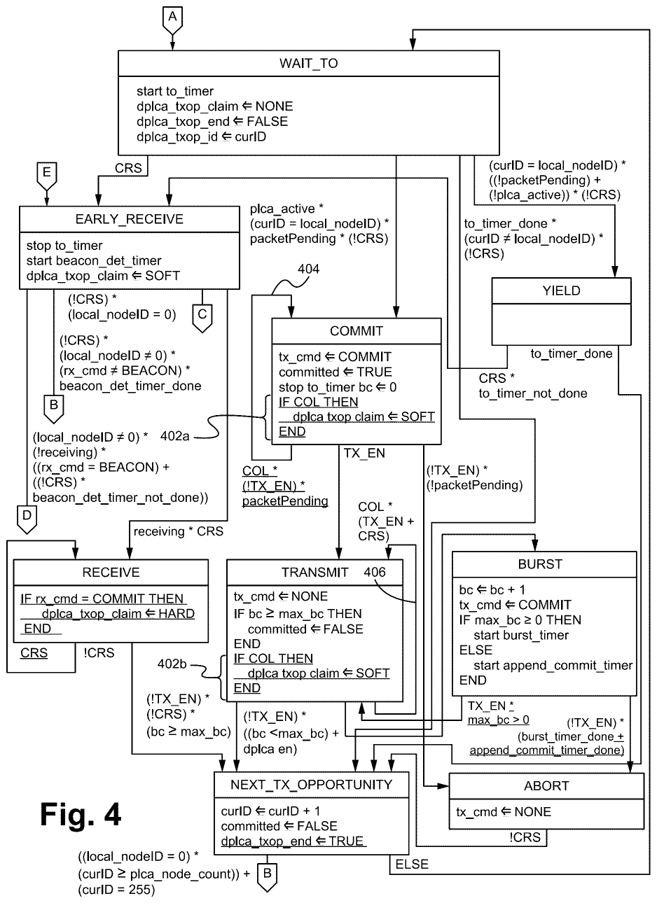

In order to prevent such follower lockup, as shown in FIG. 4, if there is a collision after the node 120 transmitted a commit signal (e.g. was in a commit state) or transmitted other data (e.g. after node 120 was in a transmit state), each of the nodes 120 (and/or the ethernet communication component 151 thereof) of the system 100 are able to be configured to apply a soft claim. For example, as shown in FIG. 4, the soft claim application 402a, b is able to comprise IF COL; dplca_txop_claim≤SOFT; END. Alternatively, each of the nodes 120 are able to instead apply a generic claim such that 402a, b is a “generic” claim application. Alternatively, the soft claim application 402a, b is able to be omitted. Alternatively, Further, if the follower node 120 was transmitting a commit signal (e.g. was in a commit state), the node 120 is able to perform a return transition to the commit state where the node returns to the beginning of the commit state if: a collision was detected; a transmit permission parameter of the node 120 indicates that transmission of data by the node 120 is not enabled; and the node 120 has pending data/packets that needs to be transmitted. For example, as shown in FIG. 4, the commit return transition 404 is able to be conditioned on COL & !TX_EN & packetpending. Similarly, if the follower node 120 was transmitting a data signal (e.g. was in a transmit state), the node 120 is able to perform a return transition to the transmit state where the node 120 returns to the beginning of the transmit state if: a collision was detected; and either a transmit permission parameter of the node 120 indicates that transmission of data by the node 120 is enabled or a CRS signal is detected (where a CRS signal indicates that a collision has been detected and is transmitted on the bus 110 by nodes 120 that were not a part of the collision). For example, as shown in FIG. 4, the transmit return transition 406 is able to be conditioned on COL & (TX_EN|CRS). Thus, the system 100 provides the benefit of avoiding follower lockup situations by enabling the nodes to return to the commit or transmit states upon detection of a collision.

In some embodiments, the nodes 120 are able to detect that a collision has occurred when they receive data/signal during a time slot or transition opportunity in which they have already transmitted data (e.g. beacon, commit, other data). Specifically, the received signal/data indicates that another node 120 has also transmitted this received data/signal and thus, this other data has collided with the data transmitted by the current node 120. In some embodiments, upon detecting a collision that they are a part of, the nodes 120 are able to output a collision signal, and upon detection of a collision that they are not a part of, they are able to output a CRS signal.

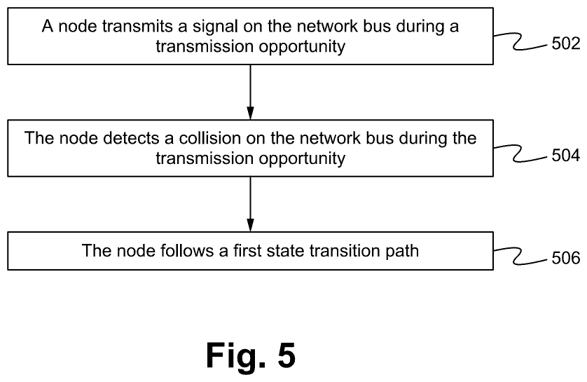

FIG. 5 illustrates a method of providing a single pair ethernet multidrop network according to some embodiments. As shown in FIG. 5, a node 120 transmits a signal on the network bus 110 during a transmission opportunity at the step 502. The node 120 detects a collision on the network bus 110 during the transmission opportunity at the step 504. In particular, the node 120 detects a collision caused by the first signal and a second signal transmitted by another node 120 on the network bus 110 during the same transmission opportunity. The node 120 follows a first state transition path at the step 506. In particular, the first state transition path transitions the node 120 back into a first state (that the node 120 was in when it transmitted the first signal). In some embodiments, the method further comprises, when the node 120 detects a collision, setting with the node 120 a dplca_txop_claim value equal to SOFT indicating that a soft claim was made for the transmission opportunity. In some embodiments, the first signal is a commit signal that indicates that the node 120 needs to transmit pending data packets during the transmission opportunity. In some embodiments, the first state is a commit state and the first state transition path is conditioned upon: the node 120 detecting the collision; the node 120 not having packet transmission enabled; and the node 120 needing to transmit the pending data packets on the network bus 110. In some embodiments, the first signal is a data packet signal including data received from a media access control 214 of the node 120. In some embodiments, the first state is a transmit state and the first state transition path is conditioned upon: the node 120 detecting the collision; and one or both of the node 120 having packet transmission enabled and the node 120 receiving a CRS signal indicating another of the nodes 120 detected the collision.

### Node Count Detection

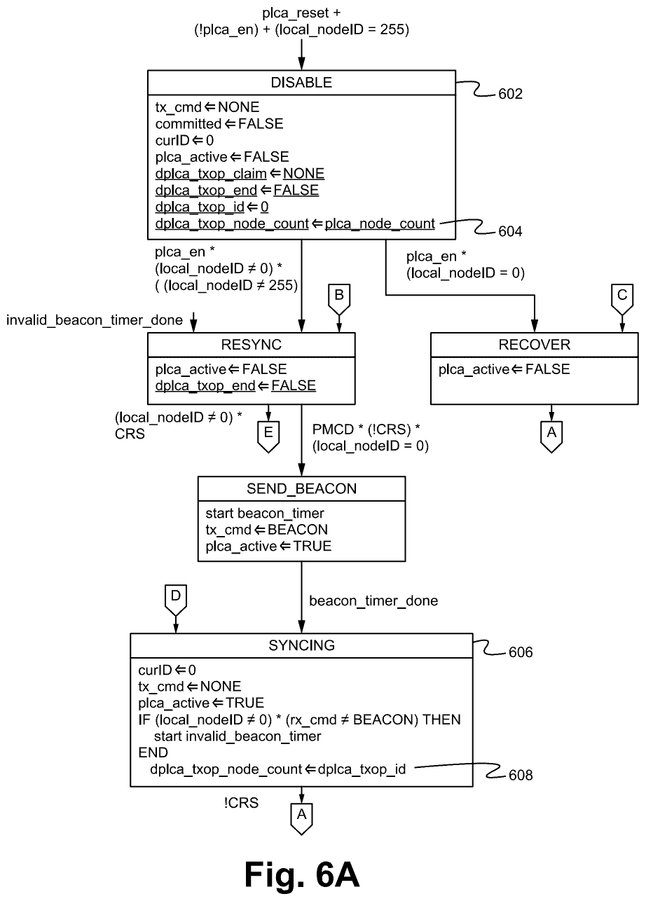

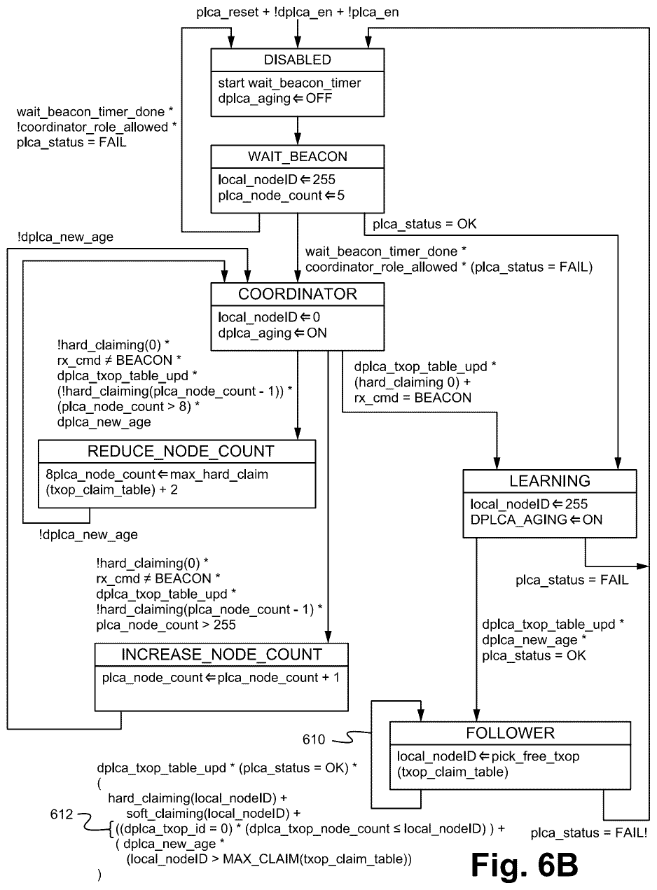

In some embodiments both in normal operation and when trying to determine an available unique node identifier as described above, follower nodes 120 are able to end up attempting to use unique node IDs (e.g. local_nodeID) that are greater than the current number of node IDs (and/or time slots or TOs) being supported by the coordinator node 120 (e.g. dplca_txop_id). In IEEE P802.3da, this situation then results in follower nodes 120 being unable to transmit data because none of the time slots/TOs correspond to the follower nodes'120 node IDs. Additionally, IEEE 802.3da draft 1.0 lacks a mechanism that enables the follower nodes 120 to detect the current number of node IDs (and/or time slots or TOs) being supported by the coordinator node 120 (e.g. the current value of dplca_txop_id). As a result, the follower nodes 120 are stuck being both unable to transmit data and unable to determine that they need to select new unique node IDs. In order to prevent such node count detection issues, as shown in FIG. 6A, the follower nodes 120 (and/or the ethernet communication component 151 thereof) are able to store (e.g. in memory 157) a current node count value (e.g. dplca_txop_node_count) that indicates the current number of node IDs (and/or time slots or TOs) being supported by the coordinator node 120 (e.g. dplca_txop_id). In particular, this current node count value is able to be initialized 604 by the node 120 when in the disable state 602 (e.g. when first joining or re-joining the network) to be equal to the number of nodes/node IDs/time slots detected when listening to a full communication cycle (e.g. equal to plca_node_count) in the process of selecting a temporary/local node ID as described above. Subsequently, when in a syncing state 606, the follower nodes 120 are able to update 608 the current node count value so that it remains synchronized with the current number of node IDs (and/or time slots or TOs) being supported by the coordinator node 120 (e.g. set dplca_txop_node_count equal to the current value of dplca_txop_id). As a result, the follower nodes 120 are able to keep track of the largest unique node ID that is currently being supported by the coordinator node 120.

Further as shown in FIG. 6B, when in the follower state, the follower nodes 120 are able to use a follower state return transition path 610 in order to select a new unique node ID (e.g. local_nodeID). This selection is able to be substantially similar to the initial selection process as described above wherein a new unique node ID is selected from a set of available node IDs (e.g. as indicated in the node ID table). For example, the follower nodes 120 are able to use the follower state return transition path 610 based on the current time slot/node ID/TO being the first one of a new cycle (e.g. dplca_txop_id=0) and the current node count value being less than or equal to the follower node's current unique node ID (e.g. dplca_txop_node_count≤local_nodeID). In some embodiments, in addition to the above conditions, the follower state return transition path 610 is able to further be conditioned on the transmission opportunity table being updated and the physical layer collision avoidance protocol status being okay (e.g. dplca_txop_table_upd * (plca_status=OK) * (dplca_txop_id=0) * (dplca_txop_node_count≤local_nodeID)). As a result, even when one of the follower nodes 120 ends up with a unique node ID that is greater than the largest currently supported node identifier, the follower node 120 is able to keep track of the largest currently supported node identifier and follow the follower state return transition path 610 to select a new unique node identifier whenever that is the case.

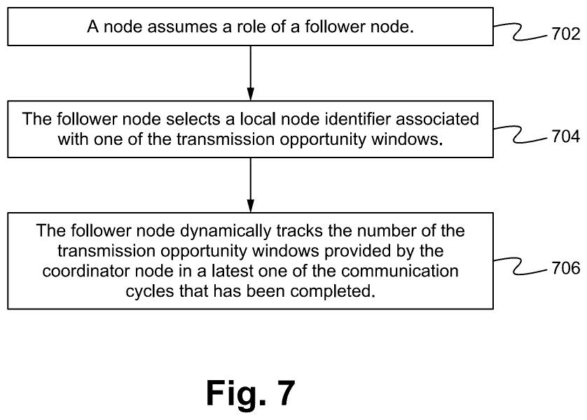

FIG. 7 illustrates a method of providing a single pair ethernet multidrop network according to some embodiments. As shown in FIG. 7, a node 120 assumes a role of a follower node at the step 702. The follower node 120 selects a local node identifier associated with one of the transmission opportunity windows at the step 704. The follower node 120 dynamically tracks the number of the transmission opportunity windows provided by the coordinator node 120 in a latest one of the communication cycles that has been completed at the step 706. As a result, the method provides the advantage of enabling the follower node 120 to keep track of a number of nodes/time slots currently being supported by the coordinator node 120 such that if its local node is too large (i.e. larger than node ID associated with the last time slot of the cycle), the follower node 120 is able to select a different node ID.

In some embodiments, the method further comprises dynamically tracking the number of the transmission opportunity windows provided by the coordinator node in the latest one of the communication cycles with the follower node 120 by synchronizing a local node count value with a coordinator node count value after the completion of the latest one of the communication cycles. In some embodiments, the method further comprises, after each of the communication cycles, determining with the follower node 120 if the local node identifier was not associated with any of the transmission opportunity windows of the latest one of the communication cycles. In some embodiments, the method further comprises determining if the local node identifier was not associated with any of the transmission opportunity windows of the latest one of the communication cycles with the follower node 120 by determining if the local node count value is less than the local node identifier. In some embodiments, the method further comprises, with the follower node 120 selecting the local node identifier when in a follower state and following a state transition path that transitions the follower node 120 from the follower state back into the follower state when the local node identifier was not associated with any of the transmission opportunity windows of the latest one of the communication cycles. In some embodiments, the method further comprises, upon entering the follower state after following the state transition path, selecting a different local node identifier with the follower node 120. In some embodiments, use of the state transition path by the follower node 120 is conditioned upon the local node count value of the communication component being less than the local node identifier of the follower node 120. In some embodiments, the method further comprises, when in a disable state, initializing the local node count value to be equal to default node count value with the follower node 120.

### Coordinator to Learning State Transition

In some embodiments in normal operation as described above, a node 120 that has assumed the coordinator role is able to receive a beacon signal from one of the other nodes 120 thus indicating that this other node 120 also is attempting to assume the coordinator role. In IEEE 802.3da draft 1.0, this situation can result in a conflict between the two nodes 120 because the node 120 that received the beacon signal is unable to transition from the coordinator state to a learning state (in which the node relinquishes the coordinator state). In particular, IEEE 802.3da draft 1.0 only enables the coordinator node 120 to transition from the coordinator state to the learning state if both a beacon signal is received that cycle (e.g. rx_cmd=BEACON) and the transmission opportunity table needs to be updated and/or is currently being updated (e.g. dplca_txop_table_upd=true). For example, after/during communication cycles, the transmission opportunity table is able to be or need to be updated to have a different number of transmission opportunities in the next communication cycle and/or other changes (e.g. different order of transmission opportunities). However, those two parameters are not able to be true for the coordinator node 120 simultaneously and as a result, the coordinator node 120 is unable to properly react to the receipt of the beacon signal.

In order to prevent such coordinator state transition issues, as shown in FIG. 8, when in the coordinator state 802, the coordinator node 120 is able to transition 804 to the learning state 806 when a beacon signal is received (e.g. rx_cmd=BEACON) without requiring that the transmission opportunity table simultaneously being updated (e.g. dplca_txop_table_upd=true). As a result, upon receiving a beacon signal in the coordinator state 802, the coordinator node 120 (and/or the ethernet communication component 151 thereof) is able to transition to the learning state 806. Once in the learning state 806, the node 120 (now no longer the coordinator node) is able to select a new unique node ID (e.g. local_nodeID) using the selection method described above. Further, as described above, if a beacon signal is received (and/or no collisions occur using the select node ID), the node 120 is able to transition to the follower state 808 and start normal follower node 120 operation as described above. If instead the beacon signal is not received during the process of selecting the new unique node ID, the node 120 is able to attempt to become the coordinator node 120 once again in the manner described above (e.g. via the disable and/or wait beacon states). Thus, the system 100 provides the benefit of enabling coordinator nodes 120 to efficiently relinquish their coordinator state upon receiving a beacon signal which prevents network disruption during the DPLCA process.

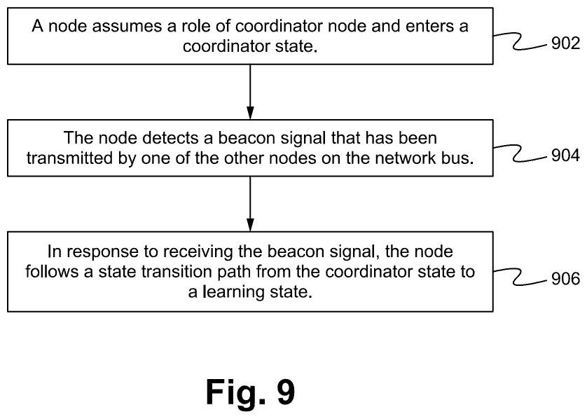

FIG. 9 illustrates a method of providing a single pair ethernet multidrop network according to some embodiments. As shown in FIG. 9, a node 120 assumes a role of coordinator node and enters a coordinator state at the step 902. In particular, the node 120 is able to assume role of the coordinator node after not detecting a beacon signal during the process of selecting a unique node ID as described above. Alternatively, the node 120 is able to assume the role of the coordinator under different circumstances. The node 120 detects a beacon signal that has been transmitted by one of the other nodes 120 on a network bus 110 of the network at the step 904. The node 120, in response to receiving the beacon signal, follows a state transition path from the coordinator state 802 to a learning state 806 at the step 906.

In some embodiments, use of the state transition path from the coordinator state 802 to a learning state 806 is conditioned on the receipt of the beacon signal. In some embodiments, the method further comprises, when in the coordinator state 804, the node 120 using one node identifier and when in the learning state 806, selecting and/or using a new/different node identifier. In some embodiments, the method further comprises, when in the coordinator state 804, issuing an initial beacon signal with the node 120 at a start of each of the communication cycles (e.g. in accordance with normal operation as describe above). In some embodiments, the method further comprises when in the learning state 806, the node 120 listening to a next one of the communication cycles before selecting the new node identifier.

### Wait Beacon Lockup

In some embodiments when trying to determine an available unique node identifier (and/or in normal operation) as described above, a node 120 is able to set its node identifier to the highest supported value (e.g. set local_nodeID=255). Additionally, some nodes 120 are not be permitted to become the coordinator node (e.g. !coordinator_role_allowed). In IEEE 802.3da, this situation can result in the node 120 getting stuck in a state loop because if the plca_active=false and the plca_status=fail, then the node 120 is forced to cycle between the disable state 1002 and the wait_beacon state indefinitely (e.g. waiting for plca_status=OK). In particular, if its node identifier is set to the highest supported value (e.g. local_nodeID=255) in IEEE 802.3da, the node 120 is able to be forced to the disable state 1002 and it cannot leave the disable state while its node identifier is set to the highest supported value. For example, the transition from disable to the resynch state 1004 is conditioned on PLCA being enabled, the node ID not being 0 and the node ID not being the highest supported value.

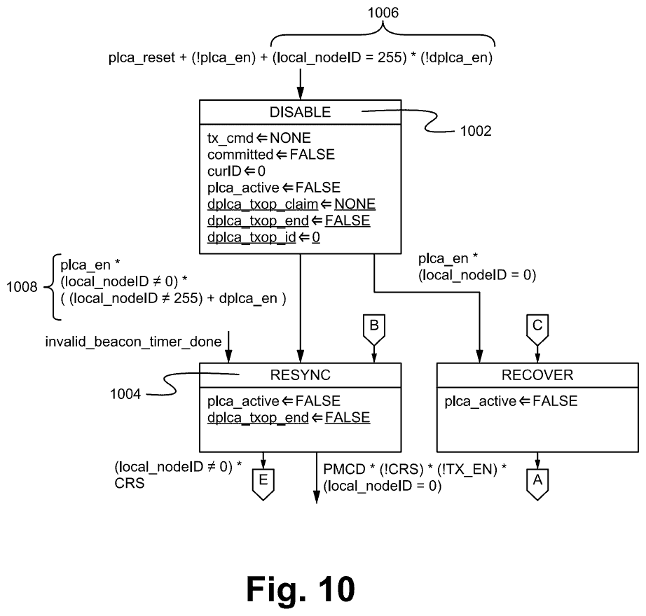

In order to prevent such wait beacon lockup issues, as shown in FIG. 10, the communication component 151 of the node 120 does not force the node 120 into the disable state 1002 (because of its node ID) unless it meets a disable condition 1006 of having both its node identifier being set to the highest supported value and its DPLCA functionality being not enabled (e.g. local_nodeID=255 * !dplca_en). As a result, a node 120 is no longer forced to the disable state 1002 because its unique node ID is set to the highest supported value as long as the node 120 supports the DPLCA functionality as described herein. Further, even when in the disable state 1002, the communication component 151 of the node 120 enables the node 120 to follow a state transition 1008 out of the disable state 1002 to the resync state 1004 even if its node ID is set to the highest supported value (which means it is not set to the lowest value of 0) as long as its PLCA functions and DPLCA are enabled (e.g. plca_en * local_nodeID≠0 * (local_nodeID≠255|dplca_en). Thus, the system 100 provides the benefit of not forcing nodes 120 into the disable state when its node ID is set to the highest supported value and enabling nodes in the disable state to transition out of the state 1002 even if their node ID is set to the highest supported value. As a result, the system, method and device increases the efficiency of the system and prevents network discrepancies due to nodes 120 being stuck in a wait_beacon and/or disable state.

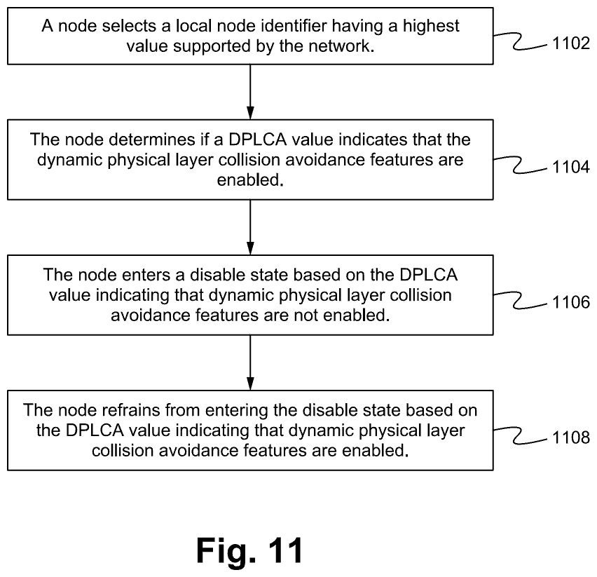

FIG. 11 illustrates a method of providing a single pair ethernet multidrop network according to some embodiments. As shown in FIG. 11, a node 120 selects a local node identifier (e.g. local_nodeID) having a highest value supported by the network at the step 1102. The node 120 determines if a DPLCA value (e.g. dplca_en) indicates that the dynamic physical layer collision avoidance features are enabled at the step 1104. The node 120 enters a disable state 1002 at the step 1106. In particular, the node 120 is able to enter the disable state 1002 based on the local node identifier being the highest value supported by the network (e.g. 255) and a stored dplca_en value indicating that dynamic physical layer collision avoidance features are not enabled for the node 120. The node 120 refrains from entering the disable state 1002 at the step 1108. In particular, the node 120 is able to refrain from entering the disable state based on the local node identifier being the highest value supported by the network and the stored dplca_en value indicating that the dynamic physical layer collision avoidance features are enabled for the node 120. In some embodiments, the method further comprises, when in the disable state and while the local node identifier is the highest value supported by the network, transitioning from the disable state 1002 to a resync state 1004 based on the dynamic physical layer collision avoidance features being enabled for the node 120. In some embodiments, the method further comprises when in the disable state 1002 and while the local node identifier is the highest value supported by the network, transitioning from the disable state 1002 to a resync state 1004 based on the local identifier being not equal to a lowest value supported by the network (e.g. 0). In some embodiments, when in the disable state 1002, the node 120 does not transmit data on the network bus 110.

### Advantages

Accordingly, the DPLCA system, method and device described herein provides numerous advantages. Specifically, the system, method and device provides the advantage over existing systems (e.g. IEEE 802.3da) of preventing node lockup due to beacon collisions thereby accelerating the DPLCA node ID resolution process and enhancing network efficiency. Further, the system, method and device provides the advantage over existing systems (e.g. IEEE 802.3da draft 1.0) by preventing network disruptions (e.g. follower lockup) by enabling return transitions which enhances network reliability and network efficiency. Moreover, the system, method ana device provides the advantage of preventing network disruptions and improving the efficiency of the network by preventing follower nodes getting stuck with a node identifier that is greater than the number of time slots/TOs/the largest currently supported node identifier. Also, the system, method and device provide the benefit of enabling coordinator nodes 120 to efficiently relinquish their coordinator state upon receiving a beacon signal which prevents network disruption during the DPLCA process. Further, the system, method and device provide the benefit of enabling transition from the coordinator state to a learning state upon receiving a beacon signal (e.g. indicating that another node is in the coordinator state) thereby preventing network disruption during the DPLCA process. Additionally, while the system, method and device has been described with reference to numerous specific details, one of ordinary skill in the art will recognize that the invention can be embodied in other specific forms without departing from the spirit of the invention. Thus, one of ordinary skill in the art will understand that the invention is not to be limited by the foregoing illustrative details. For example, although many of the features have been described separately herein for the sake of clarity, it is understood that the features are able to be combined forming a cohesive system, method and device including a combination of the described features.

Moreover, it should be noted that although not described in detail for the sake of brevity, the nodes 120 are able to comprise one or more of an integrated circuit, a software defined network, a top of rack switch, a network interface, additional memory, additional processors, I/O device(s), buses and/or a storage device. The additional memory and/or the memory described herein is able to be any conventional computer memory known in the art such as, but not limited to, a hard drive, DRAM, RAM, SRAM, CDROM, CDRW, DVD, DVDRW, flash memory card or any other storage device. An example of a network interface includes a network card connected to an Ethernet or other type of LAN. The I/O device(s) are able to include one or more of the following: keyboard, mouse, monitor, display, printer, touchscreen, button interface and other devices. In some embodiments, the shared library is able to be a driver for one or more of the I/O devices. The operating system(s), graphical user interface(s), application(s), module(s) and/or other software on the nodes 120 (and components thereof) are able to be stored in the memory and/or additional memory and/or storage device and processed as applications are typically processed via the processors and/or additional processors of the system 100. The processes are able to be implemented via hardware, software, firmware and/or a combination of two or more of hardware, software and firmware such as memory, software/firmware and/or processors to execute the software/firmware stored on the memory in order to perform the functions of the processes. In some embodiments, the system 100 is able to be implemented on a vehicle such that the nodes 120 are components of the vehicle.

We claim:

1. A single pair ethernet multidrop network that operates according to a communication protocol incorporating dynamic physical layer collision avoidance, the protocol defining repeating communication cycles each including one or more transmission opportunity windows and specifying that each of a plurality of nodes is provided one of the transmission opportunity windows in each of the communication cycles, the network comprising:
a network bus; and
the plurality of nodes each coupled to the network bus for communicating with each other, wherein one of the nodes selects a local node identifier having a highest value supported by the network and while the local node identifier of the one of the nodes is the highest value supported by the network, the one of the nodes is configured to:
enter a disable state when a stored dplca_en value indicates that dynamic physical layer collision avoidance features are not enabled for the one of the nodes; and
refrain from entering the disable state when the stored dplca_en value indicates that the dynamic physical layer collision avoidance features are enabled for the one of the nodes.

2. The network of claim 1, wherein when in the disable state, while the local node identifier of the one of the nodes is the highest value supported by the network, the one of the nodes is configured to transition from the disable state to a resync state based on the dynamic physical layer collision avoidance features being enabled for the one of the nodes.

3. The network of claim 2, wherein when in the disable state, while the local node identifier of the one of the nodes is the highest value supported by the network, the one of the nodes is configured to transition from the disable state to a resync state based on the local identifier of the one of the nodes being not equal to a lowest value supported by the network.

4. The network of claim 3, wherein the lowest value supported by the network is 0 and the highest value supported by the network is 255.

5. The network of claim 4, wherein when in the disable state, the one of the nodes does not transmit data on the network bus.

6. The network of claim 5, wherein the communication protocol incorporates IEEE 802.3da.

7. The network of claim 6, wherein the network bus comprises one of a single pair twisted cable and a segmented cable.

8. A network node for communicating in a single pair ethernet multidrop network that operates according to a communication protocol incorporating dynamic physical layer collision avoidance, the protocol defining repeating communication cycles over a network bus each including one or more transmission opportunity windows and specifying that each of the network node and a plurality of other nodes on the network is provided one of the transmission opportunity windows in each of the communication cycles, the network node comprising:
a memory;
a processor coupled with the memory; and
an ethernet communication component for communicating with the other nodes via a network bus, wherein the communication component:
selects a local node identifier having a highest value supported by the network; and
while the local node identifier of the communication component is the highest value supported by the network, the communication component:
enters a disable state when a stored dplca_en value indicates that dynamic physical layer collision avoidance features are not enabled for the communication component; and
refrains from entering the disable state when the stored dplca_en value indicates that the dynamic physical layer collision avoidance features are enabled for the communication component.

9. The network node of claim 8, wherein when in the disable state, while the local node identifier of the communication component is the highest value supported by the network, the communication component is configured to transition from the disable state to a resync state based on the dynamic physical layer collision avoidance features being enabled for the communication component.

10. The network node of claim 9, wherein when in the disable state, while the local node identifier of the communication component is the highest value supported by the network, the communication component is configured to transition from the disable state to a resync state based on the local identifier of the communication component being not equal to a lowest value supported by the network.

11. The network node of claim 10, wherein the lowest value supported by the network is 0 and the highest value supported by the network is 255.

12. The network node of claim 11, wherein when in the disable state, the communication component does not transmit data on the network bus.

13. The network node of claim 12, wherein the communication protocol incorporates IEEE 802.3da.

14. The network node of claim 13, wherein the network bus comprises one of a single pair twisted cable and a segmented cable.

15. A method of providing a single pair ethernet multidrop network that operates according to a communication protocol incorporating dynamic physical layer collision avoidance, the protocol defining repeating communication cycles each including one or more transmission opportunity windows and specifying that each of a plurality of nodes is provided one of the transmission opportunity windows in each of the communication cycles, the method comprising:
with a first node of the plurality of nodes coupled to a network bus of the network:
selecting a local node identifier having a highest value supported by the network; and
while the local node identifier of the first node is the highest value supported by the network:
entering a disable state when a stored dplca_en value indicates that dynamic physical layer collision avoidance features are not enabled for the first node; and
refraining from entering the disable state when the stored dplca_en value indicates that the dynamic physical layer collision avoidance features are enabled for the first node.

16. The network of claim 15, further comprising, when in the disable state and while the local node identifier of the first node is the highest value supported by the network, transitioning from the disable state to a resync state with the first node based on the dynamic physical layer collision avoidance features being enabled for the first node.

17. The network of claim 16, further comprising when in the disable state and while the local node identifier of the first node is the highest value supported by the network, transitioning from the disable state to a resync state with the first node based on the local identifier being not equal to a lowest value supported by the network.

18. The network of claim 17, wherein the lowest value supported by the network is 0 and the highest value supported by the network is 255.

19. The network of claim 18, wherein when in the disable state, the first node does not transmit data on the network bus.

20. The method of claim 19, wherein the communication protocol is IEEE 802.3da.

21. The method of claim 20, wherein the network bus comprises one of a single pair twisted cable and a segmented cable.

22. A single pair ethernet multidrop network that operates according to a communication protocol incorporating dynamic physical layer collision avoidance, the protocol defining repeating communication cycles each including one or more transmission opportunity windows and specifying that each means for communicating is provided one of the transmission opportunity windows in each of the communication cycles, the network comprising:
means for transmitting electronic data; and
the means for communicating each coupled to the means for transmitting for communicating with each other, wherein one of the means for communicating selects a local node identifier having a highest value supported by the network and while the local node identifier of the one of the means for communicating is the highest value supported by the network, the one of the means for communicating is configured to:
enter a disable state when a stored dplca_en value indicates that dynamic physical layer collision avoidance features are not enabled for the one of the means for communicating; and
refrain from entering the disable state when the stored dplca_en value indicates that the dynamic physical layer collision avoidance features are enabled for the one of the means for communicating.
